(19) United States
(12) Patent Application Publication
(10) Pub. No.: US 2009/0150174 A1
(43) Pub. Date: Jun. 11, 2009

(54) Healthcare management system having improved printing of display screen information

(75) Inventors: Schuyler Buck, Muncie, IN (US); Morris J. Young, Indianapolis, IN (US); Jason Bush, Fishers, IN (US)

Correspondence Address: BAKER & DANIELS LLP / ROCHE, 300 NORTH MERIDIAN STREET, SUITE 2700, INDIANAPOLIS, IN, 46204, US

(73) Assignee: Roche Diagnostics Operations, Inc., Indianapolis, IN (US)

(21) Appl. No.: 11/999,855

(22) Filed: Dec. 7, 2007

(51) Int. Cl. G06Q 50/00

(52) U.S. Cl. 705/2

(57) ABSTRACT

A healthcare management system generates stylized reports of the physiological information from a display portion of the user interface using a pre-formatted report structure for each of a plurality of different display screens.

### FIELD OF THE INVENTION

The present invention relates generally to a healthcare management system for tracking patient data and generating reports from the patient data. More particularly, the present invention relates to improved printing of reports from a display screen of a user interface of the healthcare management system.

### BACKGROUND AND SUMMARY OF THE INVENTION

To reduce the frequency of necessary visits to doctors, the idea of home care gained popularity over the recent years. Technological advancements in medicine led to the increased use of medical devices. Medical devices are used to facilitate the collection of medical information without unduly disturbing the lifestyle of the patient. A large number of medical devices for monitoring various body functions are commercially available. Also, medical treatment and healthcare may require monitoring of exercise, diet, meal times, stress, work schedules and other activities and behaviors.

Many of these medical devices, such as meters and medicine delivery devices, are able to collect and store measurements and other data for long periods of time. Other devices, such as computers, portable digital assistants (PDAs), and cell phones, have been adapted to medical uses by the development of software directed to the collection of healthcare data. These advancements led to the development of health management systems that enable collection and use of large numbers of variables and large amounts of healthcare data.

A common feature of health management systems is the ability to convey information. Information can include raw data, graphical representations of data such as statistical display objects, explanations and textual interpretations, inferential information and so on. Communication and understanding can be improved by using interactive graphs and reports to convey information. Interactivity is achieved using computing devices and software applications. Generally described, individuals can interact with software applications residing on computing devices, such as personal computers, hand-held computers, mobile computing devices, and the like in a variety of ways. In one particular embodiment, the development of graphical user interfaces (GUI) facilitates user interaction with these various software applications resident in the computing device. For example, a user may manipulate a graphical user interface to interact with a data processing application or to communicate with other computing devices and/or users via a communication network.

As discussed above, many fields of medical treatment and healthcare require monitoring of certain body functions, physical states and conditions, and patient behaviors. For patients suffering from diabetes, for example, a regular check of the blood glucose level forms an essential part of the daily routine. The blood glucose level has to be determined quickly and reliably, often several times per day. Healthcare management systems store physiological information data from a plurality of patients and use this physiological information data to generate reports, graphs or other information for review by the patient, healthcare professionals, managed care providers, health maintenance organizations (HMOs) or payors such as insurance companies. Such reports and graphs may include, for example, diaries of blood glucose values and reports showing a plurality of blood glucose values and the times or times blocks to which the blood glucose values correspond. Exemplary reports may include standard day reports wherein the blood glucose values are grouped according to the time of day taken, standard week reports wherein the blood glucose values are grouped according to the day of the week taken, trend graphs to illustrate temporal trends in blood glucose values, and other suitable reports and/or graphs.

Users of healthcare management systems often browse through various screens on a display of the graphical user interface to review physiological information. It is often helpful to print, fax, e-mail, or store electronic files containing certain physiological information viewed on the display. Conventional healthcare management systems make it difficult to print, e-mail or fax on-screen content from the display of the graphical user interface. Typically, multiple applications are used to capture the on-screen content, open it in an editable form, edit the information, and then print the content in a stylized report format.

The present invention provides an easy, comprehensive and understandable stylized and pre-formatted report structure for on-screen physiological information and non-physiological information to facilitate communication of the information between patients, healthcare professionals, managed care providers, health maintenance organizations, and payors such as insurance companies. The healthcare management system of the present invention captures on-screen physiological information and presents the information in a pre-formatted standardized report structure. The reports can be output from the healthcare management system in a number of ways including a printed report, e-mail, fax or an electronic file. While prior art systems may print blood glucose graphs in a report format, the present invention uses the standardized report structure applied to multiple display screens of the user interface related to multiple features and functions for printing the displayed information within the healthcare management system.

In one illustrated embodiment of the present invention, a healthcare management system is configured to receive and process physiological information data related to at least one patient. The healthcare management system comprises a computing device configured to access and download physiological information data from, a memory accessible by the computing device to store the downloaded physiological information data, a user interface having a display which receives display information from computing device, and software configured to operate on the computing device and implement a plurality of features and functions to manage the physiological information data. The software includes instructions to display a plurality of user inputs on a menu portion of the display of the user interface to permit selections from the plurality of features and functions. The software also includes instructions to display physiological information on a display portion of the display of the user interface adjacent the menu portion, the physiological information being displayed on the display portion of a plurality of different display screens based on the user input selections from the menu portion. The system further comprises means for generating a stylized report of the physiological information from the display portion of any of the plurality of different display screens. The generating means uses a pre-formatted report structure for each of the plurality of different display screens.

In another illustrated embodiment of the present invention, a method for providing a stylized report of the physiological information from a healthcare management system is disclosed. The healthcare management system is configured to receive and process physiological information data related to at least one patient. The healthcare management system comprises a computing device configured to access and download physiological information data, a memory accessible by the computing device to store the downloaded physiological information data, and a user interface having a display which receives display information from the computing device. The illustrated method comprises providing a plurality of different features and functions to manage the physiological information data, displaying a plurality of user inputs on a menu portion of the display of the user interface, receiving a first user input selection from the user interface to select one of the plurality of different features and functions, and displaying physiological information on a display portion of the display of the user interface adjacent the menu portion. The physiological information is illustratively displayed on the display portion of a plurality of different display screens depending on the first user input received during the receiving step. The method also comprises receiving a second user input to send physiological information being displayed on the display portion of the user interface to an output device, generating a stylized report of the physiological information from the display portion of the user interface using a pre-formatted report structure for each of the plurality of different display screens, and sending the stylized report to the output device.

Additional features and advantages of the present invention will become apparent to those skilled in the art upon consideration of the following detailed description of illustrative embodiments exemplifying the best mode of carrying out the invention as presently perceived.

### BRIEF DESCRIPTION OF DRAWINGS

The detailed description of the drawings particularly refers to the accompanying figures in which:

FIG. 1 is a representation of a computing device having access to one or more output devices and access to a memory containing a patient database, and a healthcare management software system;

FIG. 2 is a representation of an exemplary computing device receiving information from a portable medical device;

FIG. 3 is an exemplary main menu screen for a healthcare management system displayed on a user interface;

FIG. 4 is an exemplary screen on the display of the user interface used to select a patient having physiological information stored in the healthcare management system;

FIG. 5 is an exemplary patient healthcare information screen on the display of the user interface;

FIG. 6 is an exemplary display screen showing settings for a summary report screen;

FIG. 7 is an exemplary summary report screen from the display of the user interface similar to FIG. 5 in which the user has scrolled down to view additional information contained in a display region of the user interface;

FIG. 8 is a pre-formatted stylized report structure used to output information from the display region of the user interface;

FIG. 9 is an exemplary summary report printed from the display screen of FIGS. 5 and 7;

FIG. 10 is an exemplary patent profile screen on the display of the user interface showing targets and events related to the patient stored in the healthcare management system;

FIG. 11 is an exemplary standard report printed from the screen of FIG. 10;

FIG. 12 is an exemplary logbook screen on the user interface of the healthcare management system showing a plurality of blood glucose and insulin data entries for the patient;

FIG. 13 is an exemplary logbook report printed from the screen of FIG. 12;

FIG. 14 is an exemplary Standard Week Graph for the patient displayed in the display of the user interface; and

FIG. 15 is an exemplary Standard Week Report printed from the screen of FIG. 14.

### DETAILED DESCRIPTION OF THE DRAWINGS

For the purposes of promoting an understanding of the principles of the invention, reference will now be made to the embodiments illustrated in the drawings, which are described below. The embodiments disclosed below are not intended to be exhaustive or limit the invention to the precise form disclosed in the following detailed description. Rather, the embodiments are chosen and described so that others skilled in the art may utilize their teachings. It will be understood that no limitation of the scope of the invention is thereby intended. The invention includes any alterations and further modifications in the illustrated devices and described methods and further applications of the principles of the invention which would normally occur to one skilled in the art to which the invention relates.

The present invention relates to a system and method for performing certain operations as described. This system may be specifically constructed for the required purposes or it may comprise a general purpose computer as selectively activated or reconfigured by a computer software application stored in the computer. The algorithms presented herein are not inherently related to any particular computer or other apparatus. In particular, various general purpose machines may be used with software applications written in accordance with the teachings herein, or it may prove more convenient to construct more specialized apparatus to perform the required method steps. The required structure for a variety of these machines will appear from the description below. Although the following description details operations in terms of a graphic user interface using display objects, the present invention may be practiced with text based interfaces, or even with voice or visually activated interfaces.

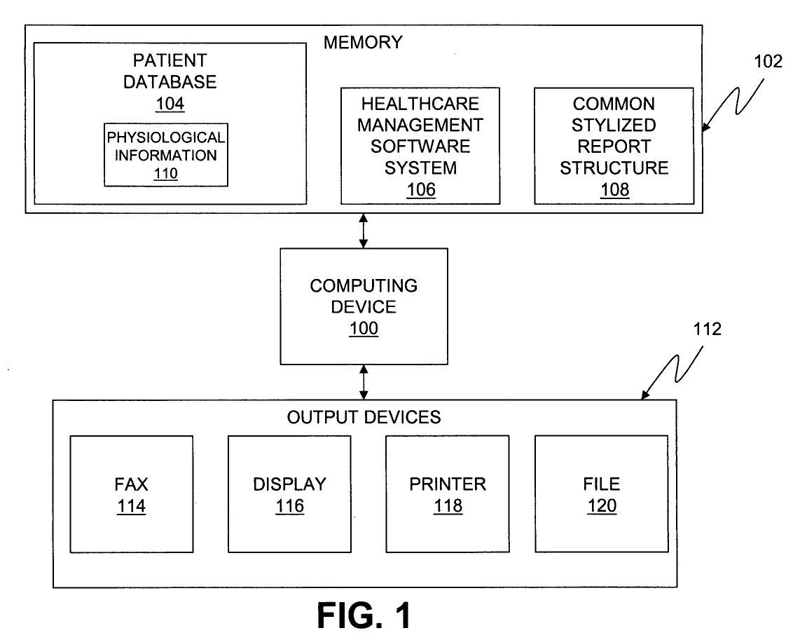

Referring to FIG. 1, a computing device 100 is shown. Computing device 100 may be a general purpose computer or a portable computing device. Although computing device 100 is illustrated as a single computing device, it should be understood that multiple computing devices may be used together, such as over a network or other methods of transferring data. Exemplary computing devices include desktop computers, laptop computers, personal data assistants (“PDA”), such as BLACKBERRY brand devices, cellular devices, tablet computers, infusion pumps, blood glucose meters, or an integrated device including a glucose measurement engine and a PDA or cell phone.

Computing device 100 has access to a memory 102. Memory 102 is illustratively a computer readable medium and may be a single storage device or multiple storage devices, located either locally with computing device 100 or accessible across a network. Computer-readable media may be any available media that can be accessed by the computer 102 and includes both volatile and non-volatile media. Further, computer readable-media may be one or both of removable and non-removable media. By way of example, and not limitation, computer-readable media may comprise computer storage media. Exemplary computer storage media includes, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which can be used to store the desired information and which can be accessed by the computing device 100.

Memory 102 includes one or more patient databases 104, healthcare management software system 106, and common report printing software 108. Patient databases 104 include physiological information 110 related to one or more patients. Exemplary physiological information includes blood glucose values, Alc values, Albumin values, Albumin excretion values, body mass index values, blood pressure values, carbohydrate values, cholesterol values (total, HDL, LDL, ratio) creatinine values, fructosamine values, HbAlvalues, height values, insulin dose values, insulin rate values, total daily insulin values, ketone values, microalbumin values, proteinuria values, heart rate values, temperature values, triglyceride values, and weight values. Physiological information 110 may be provided directly by the patient, provided by a caregiver, and/or provided by one or more sensors. Exemplary sensors are provided in insulin pumps and glucose meters.

Healthcare management software system 106 includes instructions which when executed by computing device 100 present physiological information 110 or information based on physiological information 110 to an output device 112. Exemplary information presented by healthcare management software system 106 to output device 112 include diaries of blood glucose values and reports showing a plurality of blood glucose values. Exemplary reports include standard day reports wherein the blood glucose values are grouped according to the time of day taken, standard week reports wherein the blood glucose values are grouped according to the day of the week taken, trend graphs to illustrate temporal trends in blood glucose values, and other suitable reports.

Computing device 100 has access to output device 112. Exemplary output devices 112 include fax machines 114, displays 116, printers 118, and files 120. Files 120 may have various formats. In one embodiment, files 120 are portable document format (PDF) files. In one embodiment, files 120 are formatted for display by an Internet browser, such as internet Explorer available from Microsoft of Redmond, Wash., and may include one or more of HyperText Markup Language (“HTML”), or other formatting instructions. In one embodiment, files 120 are files stored in memory 102 for transmission to another computing device and eventual presentation by another output device or to at least influence information provided by the another output device. Files 120 may be sent to another computing device by e-mail, download or other suitable method.

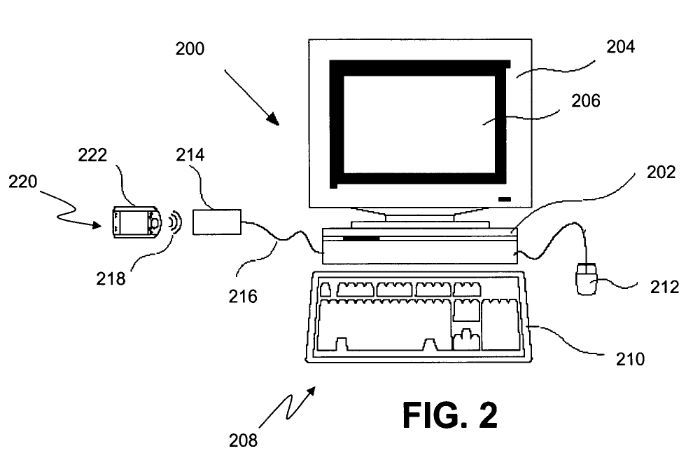

In one embodiment, healthcare management software system 106 is diabetes care software which is loaded on a computing device 100. The diabetes care software interacts with a blood glucose meter to receive blood glucose values and other physiological information. The diabetes care software system then is able to present the blood glucose values to the patient or caregiver for review as discussed below. Referring to FIG. 2, an exemplary computing device 200 is shown. In one embodiment, installation software installs a diabetes care software system on computing device 200. In an illustrated embodiment, computing device 200 may be a personal computer 202. Computing device 200 is coupled to an output device 204, illustratively a display screen 206. Computing device 200 is further coupled to a plurality of input devices 208. A first exemplary input device is a keyboard 210. A second exemplary input device is a mouse 212. A third exemplary input device is a modulated signal transceiver 214, in electronic communication with computer 202 through a cable 216. Transceiver 214 is configured to transmit and receive a modulated signal 218 and to establish communications to and from a portable device 220. An exemplary remote device 220 is a blood glucose meter 222.

In one embodiment, blood glucose meter 222 is assigned to a patient and associated with that patient in healthcare management software system 106. Thus, when physiological information from blood glucose meter 222 is transferred to healthcare management software system 106, the physiological information 110 from blood glucose meter 222 automatically populates database records in patient database 104 relating to that patient.

Although a blood glucose meter 222 is shown, any medical device may be implemented having data to be used by healthcare management software system 106. Medical devices 220 are devices capable of recording patient data and transferring data to software applications and may include monitors which record values of measurements relating to a patient's state and information such as the time and date when the measurement was recorded. Medical devices may also be devices configured to provide medications to patients such as, for example, insulin pumps. These devices, generally, record dosage amounts as well as the time and date when the medication was provided. It should be understood that the functionality of medical device 220 may be included within an exemplary computing device 100.

Computing device 200 may be used by the patient, a caregiver, or anyone having relevant data pertaining to a patient. Computing device 200 may be located in a patient's home, a healthcare facility, a drugstore, a kiosk, or any other convenient place. In an alternative embodiment, computing device 200 may be connected to a remote computing device, such as at a caregiver's facility or a location accessible by a caregiver, and physiological information 110 in patient database 104, or the complete patient database 104, may be transferred between them. In this embodiment, computing device 200 and the portable device 222 are configured to transfer physiological information 110 in patient database 104, or the complete patient database 104, between them through a data connection such as, for example, via the Internet, cellular communications, or the physical transfer of a memory device such as a diskette, USB key, compact disc, or other portable memory device. Computing device 200 and/or the remote device, may be configured to receive physiological information 110 from a medical device or, alternatively, to receive physiological information 110 transferred from the other of computing device 200 and the remote device.

It is understood that computing device 200 may also receive manually entered physiological and non-physiological data which may be displayed and printed as described herein. In addition, computing device 200 may receive data transferred from other systems that are not portable devices such as from an HIS/LIS system with data generated by non-portable lab analyzers, for example.

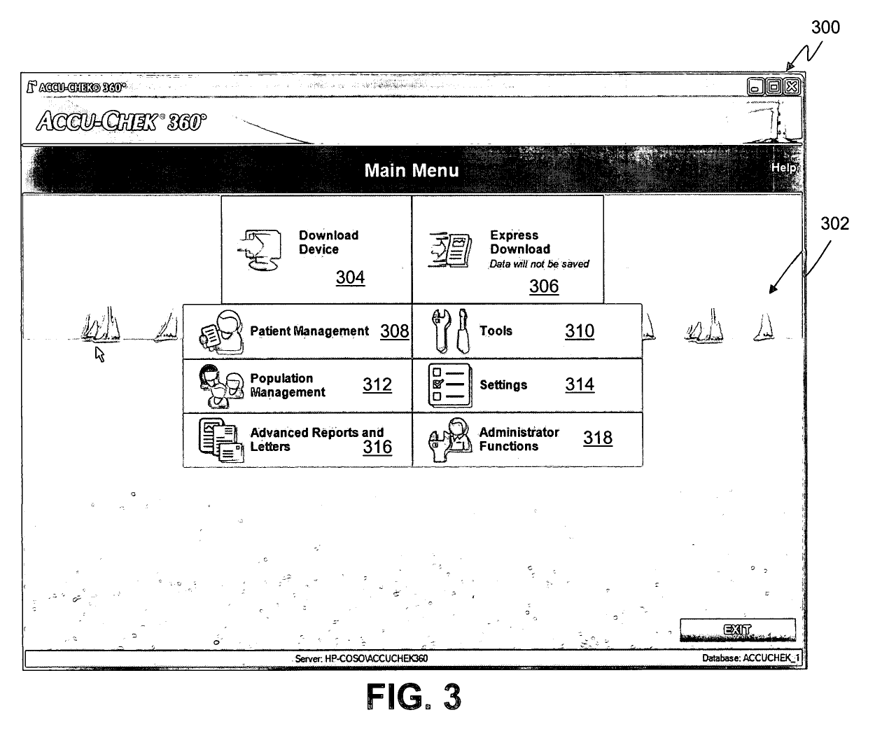

An embodiment of healthcare management software system 106 is shown in FIGS. 3-15. An exemplary screen of a graphical user interface 300 is shown, for example, in FIG. 3. A main menu screen 302 of user interface 300 includes a first selection input 304 for downloading physiological information 110 from glucose meter 222 for inclusion in patient database 104. A second selection input 306 is provided for downloading physiological information 110 from glucose meter 222, but not for storing in patient database 104. A third selection input 308 is provided for managing physiological information 110 in patient database 104 including generation of reports and entry of additional physiological information 110.

A fourth selection input 310 is provided for a tools menu. The tools menu illustratively includes selection inputs for importing physiological information 110, exporting physiological information 110, clearing physiological information 110 on a meter 222 in communication with healthcare management software system 106, setting the date and time of a meter 222 in communication with healthcare management software system 106, exporting physiological information 110 to a CSD file, determining by brand the amount of testing data communicated from a plurality of meters 222.

A fifth selection input 312 is provided for population management. Exemplary population management includes the ability to create groups based on either query groups where the database is queried to find patients that satisfy a criteria or a static group query. An exemplary static query group is a drug effectiveness group. The patients included in the drug effectiveness group are known and should not be allowed to change based on a query criteria. A sixth selection input 314 is provided for changing the settings of healthcare management software system 106. A seventh selection input 316 is provided for advanced reports and letters which allows a user to create custom reports through a report template builder and a letter builder which generates letters to patients in the database meeting a given criteria. Exemplary criteria include recent office visit, upcoming testing, and other criteria. A eighth selection input 318 is provided for administrator functions.

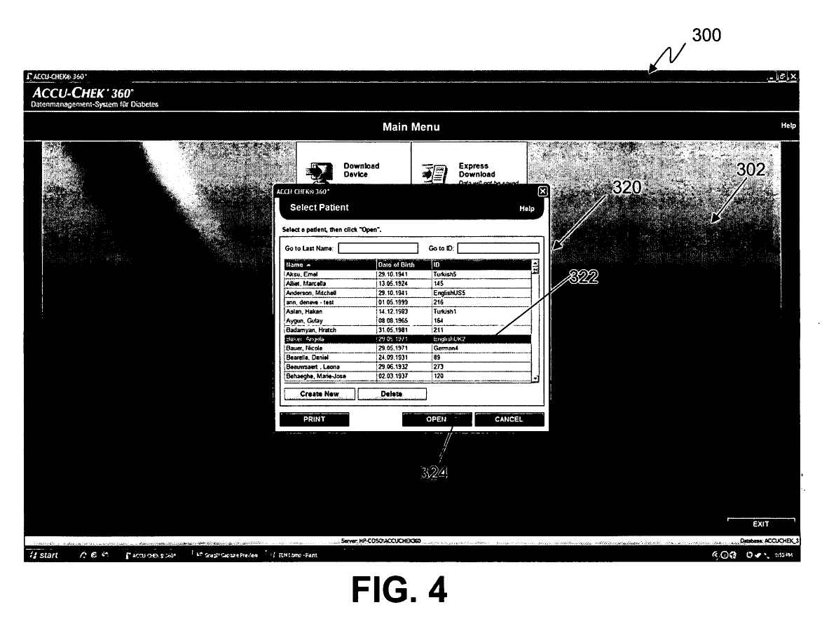

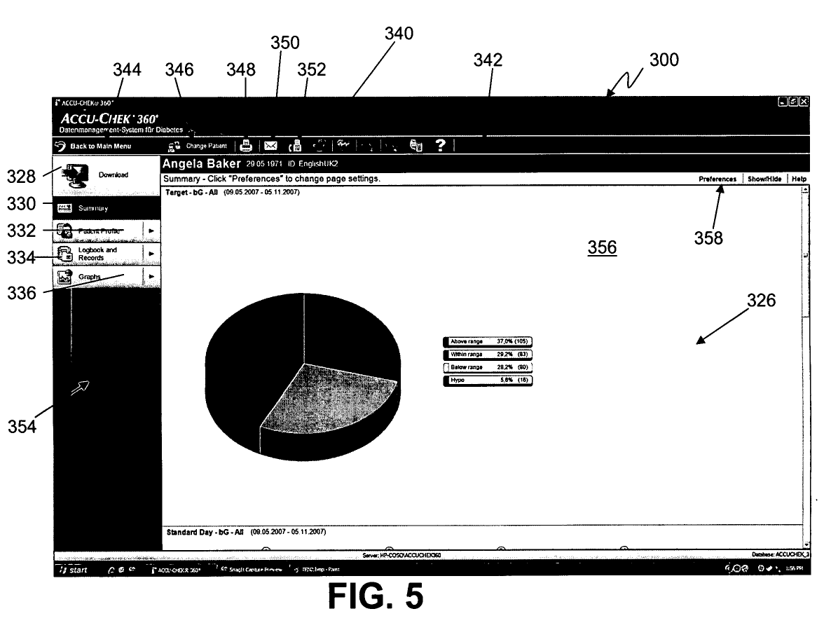

If a user of the healthcare management system 106 selects the patient management selection input 308 from FIG. 3, a Select Patient menu 320 appears on screen 302 of user interface 300 as shown in FIG. 4. The user may select a particular patient as illustrated at location 322 and then select the “Open” button 324 to view physiological information related to the selected patient as shown in FIG. 5.

FIG. 5 illustrates a screen 326 on user interface 300 for reviewing physiological information related to a selected patient. Icons 328, 330, 332, 334 and 336 illustrate various enabled and active functions of the healthcare management system 106. It is understood that these features and functions are for illustrative purposes and that other features and functions may be used in accordance with the present invention. In the illustrated embodiment, icon 328 provides a selection for downloading physiological information 110 from a portable device such as glucose meter 222 for inclusion in the patient database 104. Icon 330 relates to a summary of physiological information for the patient. Icon 332 relates to a patient profile. Icon 334 relates to patient logbooks and records. Icon 336 relates to various graphical reports of the physiological information as discussed below.

FIGS. 5-7 illustrate the summary of patient information presented on screen 326 when icon 330 is selected by the user. The display screen 326 on user interface 300 includes a title region 340, a top menu portion 342 including an input 344 to return back to the main menu of FIG. 3. Top menu portion 342 also includes an input 346 to change patients for which physiological information is displayed. Top menu 342 further includes a print input 348, an e-mail input 350, and a fax input 352. The user can select to send physiological information related to the patient to one of the output devices 112 by selecting one of the inputs 348, 350 or 352 as discussed below.

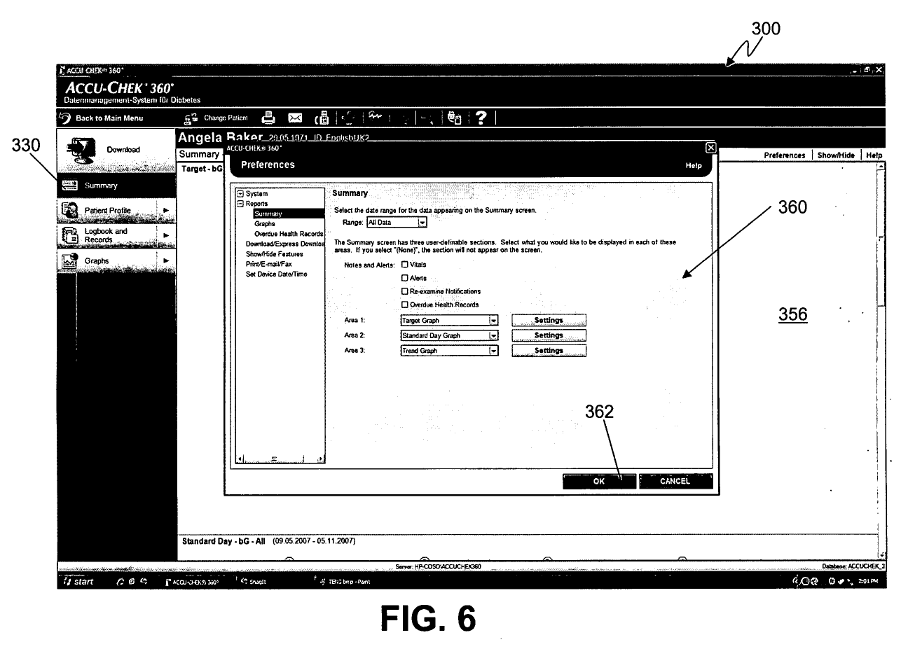

Icons 328, 330, 332, 334 and 336 are included in a side menu portion 354 on the screen 326 of user interface 300. User interface 300 also includes a physiological information display portion 356 which contains the physiological information related to the selected patient. In the illustrated embodiment of FIG. 5, a comparison of the patient's actual blood glucose readings to target blood glucose readings are shown in display 356. The patient may click a “Preferences” input 358 to change various page settings. For example, when the user clicks the “Preferences” input 358 in FIG. 5, a “Preferences” menu 360 shown in FIG. 4 appears on user interface 300. The user can then change preferences for the physiological information displayed when the summary icon 330 is selected. Once desired preferences are selected, the user selects the “OK” input 362 in FIG. 6 to automatically change the preferences displayed in display region 356.

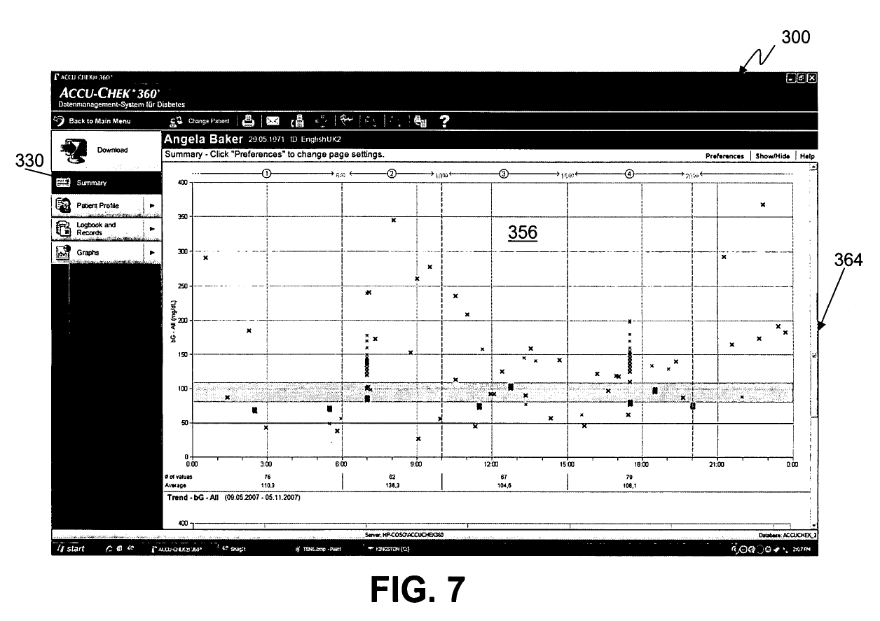

FIG. 7 illustrates further physiological information related to the patient that is displayed when the summary icon 330 is selected and when the user scrolls down further in the display portion 356 using the scroll bar 364. In other words, not all the physiological information related to the patient can be seen within the display region 356 without using the scroll bar 364 in the illustrated example.

As discussed above, it is often desirable to print the physiological information related to the patient viewed on the user interface 300. It is also desirable to fax, e-mail, or save the information as a data file. Conventional healthcare management systems often make it difficult to print, fax, or e-mail information in an easy to understand form from the graphical user interface.

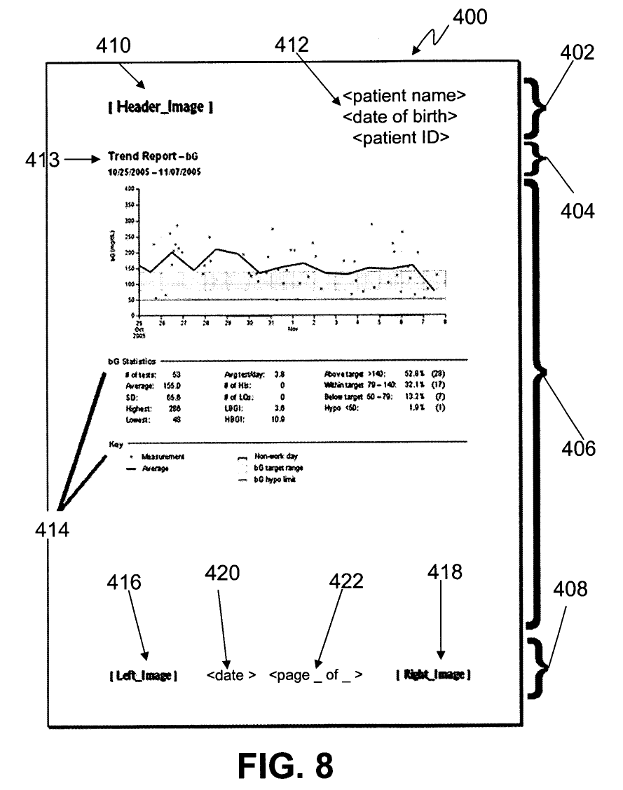

An illustrative embodiment of the present invention provides a comprehensive and understandable pre-formatted and stylized report structure for on-screen information to facilitate understanding of the information and communication of the information to others. FIG. 8 illustrates a pre-formatted report structure 400 for physiological information displayed in the display region 356 of the user interface 300. Illustratively, the structure report 400 includes a page header 402, a first page title portion 404, a content portion 406, and page footer 408.

In the illustrated embodiment of FIG. 8, the page header portion 402 includes a header image 410 which may be provided by the owner of the healthcare management systems software or other provider. For instance, the trademark of the healthcare management system or a particular healthcare provider may be stored in memory 102 and added as the header image 410 when reports are printed, faxed or e-mailed to others as discussed below. Also in the illustrative embodiment, header 402 includes patient information fields 412, which retrieve stored information related to the patient and provide the information in header 402. In the illustrative embodiment, display fields include patient name, date of birth, and patient identification information. First page title portion 404 includes a title of the report as illustrated at location 413. The content portion 406 illustratively includes the physiological information from display region 356 of user interface 300. In addition, content portion 406 may include other information such as a report block header 414.

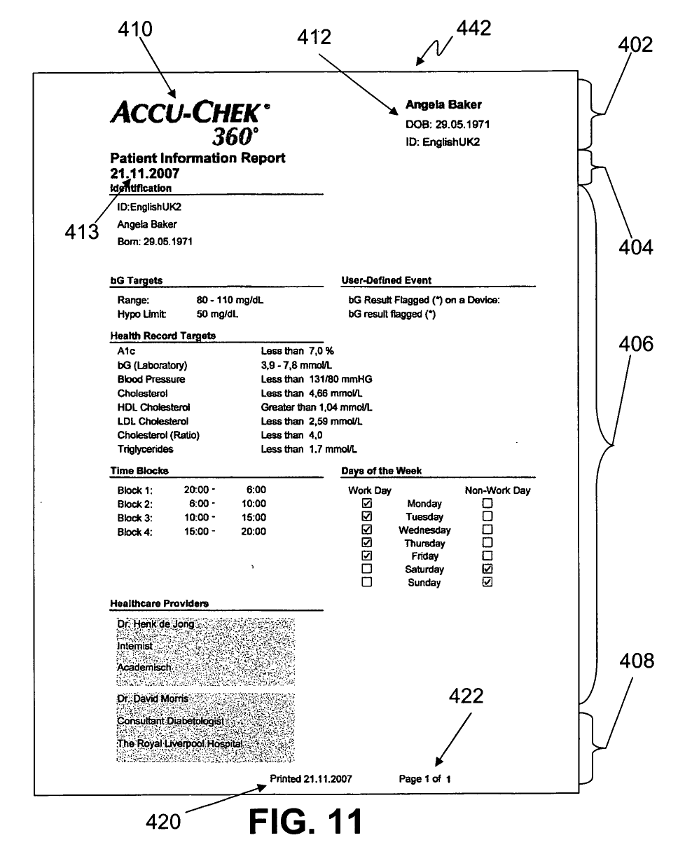

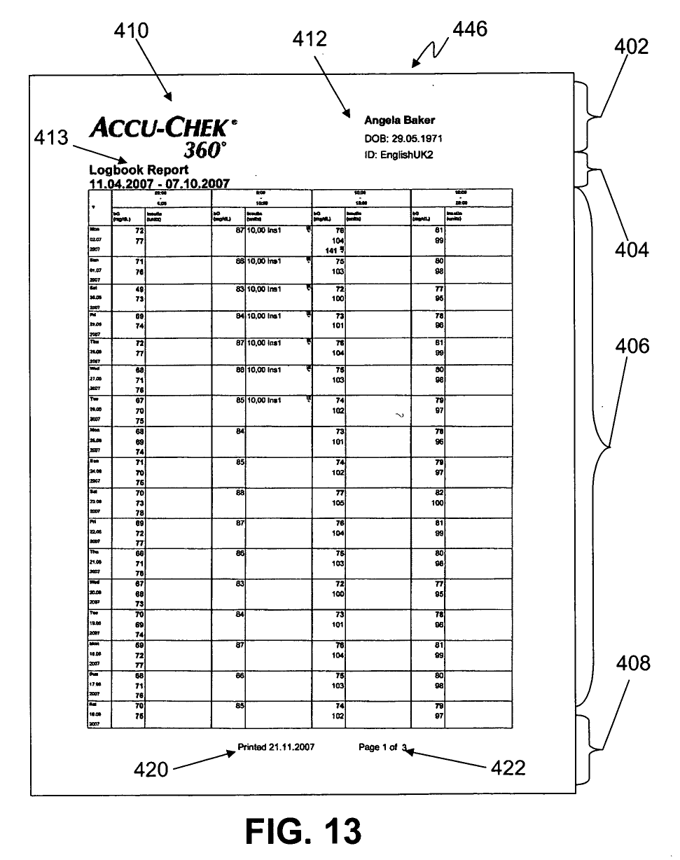

Page footer 408 illustratively includes a left image 416, a right image 418, a report date field 420 and a page number field 422. It is understood that other desired information could be included in the page header, first page title portion 404, or page footer 408, if desired left and right images 416 and 418, respectively, in footer portion 408 may include trademarks, coupons, advertisements, reminders or other information. Images 416 and 418 may be omitted as shown in FIGS. 11 and 13.

The stylized, pre-formatted report structure 400 illustrated in FIG. 8 is an exemplary report used when it is desired to print, e-mail or fax physiological information from the display portion 356 of user interface 300. Referring again to FIGS. 5 and 7, when a user desires to send the physiological information from the display region 356 to an output device 112, the user selects either the “Print” icon 348, the “E-mail” icon 350 or the “Fax” icon 352 in the upper menu portion 342. The healthcare system software 106 uses the stylized report structure illustrated in FIG. 8 to prepare a report for the specific information shown in FIGS. 5 and 7.

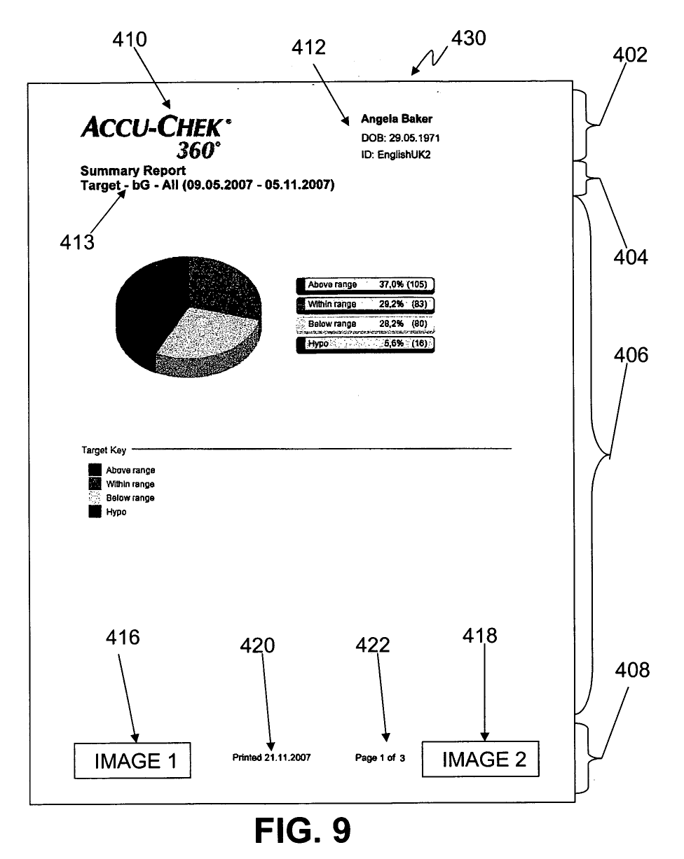

FIG. 9 illustrates a first page of the Summary Report 430 generated when the user clicks the “Print” icon 348 in FIG. 5 or 7. As illustrated in FIG. 9, a trademark is entered as the image header 410. Patient information is used to populate the fields 412 in page header 402. The title 413 is provided based on the particular screen being accessed by the user on the user interface 300. For instance, page 1 of the stylized report 430 shown in FIG. 9 corresponds to the physiological information on display screen 356 from FIG. 5. Page 2 of the Summary Report (not shown) would have the same header and footer information, with a different page number, and include the graph from FIG. 7. Therefore, the stylized, pre-formatted report structure shown in FIG. 8 is used to generate an easy to read report 430 shown in FIG. 9 from the physiological information shown in the display portions 356 of FIGS. 5 and 7. The same report structure 430 is illustratively generated when the user selects to print, e-mail, fax, or save a file related to the physiological information from display screen 356.

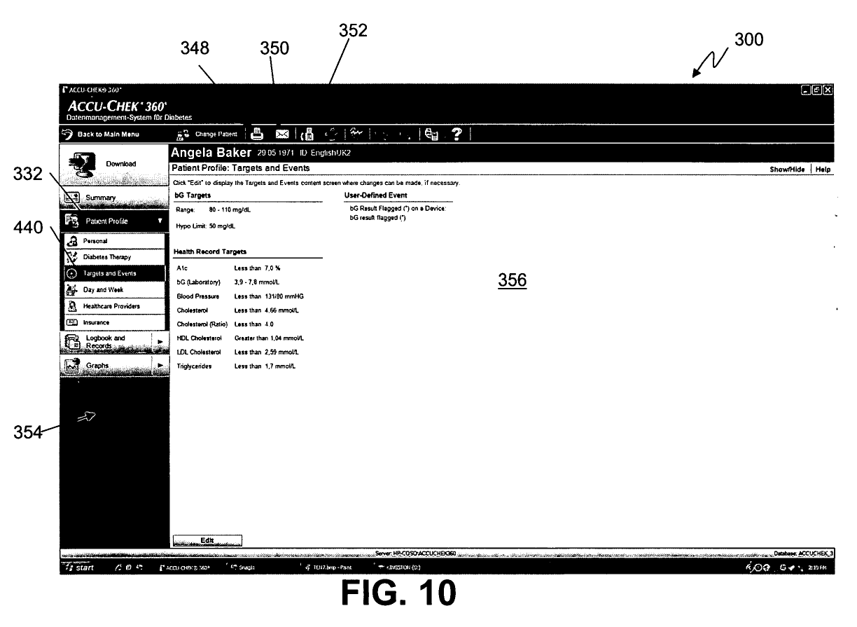

If the user selects the patient profile icon 332 on the left side menu 354 of user interface 300, certain patient profile information such as personal information, diabetes therapy, targets and events, day and week, healthcare providers, and insurance information may be selectively displayed within display portion 356 of user interface 300. In the illustrated embodiment of FIG. 10, the user has selected the “Targets and Events” icon 440. Therefore, patient profile target and events are displayed in display portion 356. When it is desired to send the physiological information from display portion 356 of FIG. 10 to an output device 112, the user selectively clicks on the print icon 346, the e-mail icon 348, or the fax icon 352 shown in FIG. 10. The healthcare management software system 106 then accesses the stylized report structure 400 illustrated in FIG. 8 and creates a stylized report 442 shown in FIG. 11 related to the physiological information shown in display portion 356 of FIG. 10. As illustrated in FIG. 11, the page header 402, first page title 404, content portion 406, and page footer portion 408 are used in the stylized pre-formatted report 442. The content portion 406 includes the physiological information from display portion 356 of FIG. 10.

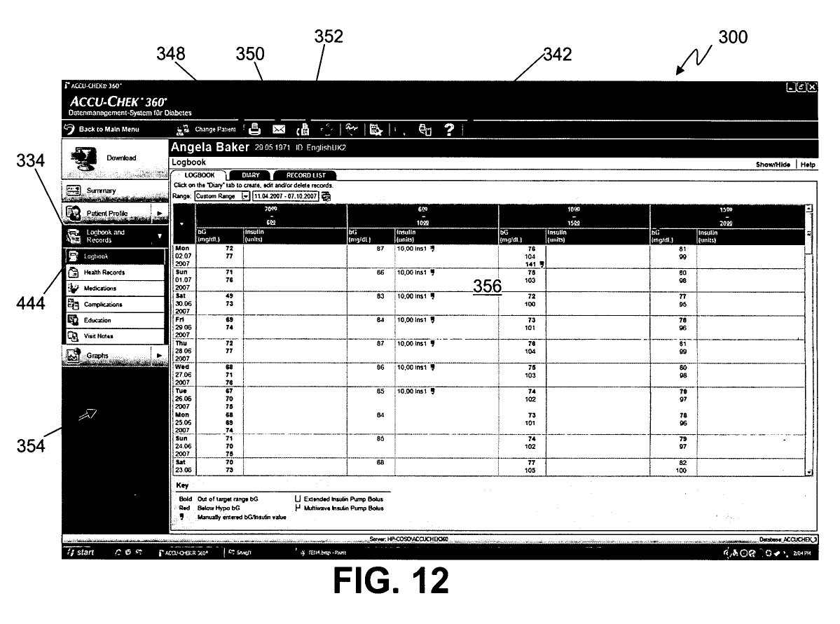

FIG. 12 illustrates the user interface 300 when the user selects the Logbook and Records icon 334 from side menu 354. The user may then select various submenu items such as the Logbook icon 444 to display additional physiological information related to the patient in the display portion 356 of user interface 300. In the illustrated embodiment, the logbook includes various blood glucose and insulin measurements either received from the blood glucose meter 222 or another input. If the user desires to send the information from display portion 356 to an output device 112, the user selects the print icon 348, the e-mail icon 350, or the fax icon 352 from the top menu 342 of user interface 300. The healthcare management software system 106 then uses the pre-formatted report structure 400 shown in FIG. 8 to generate a stylized report 446 shown in FIG. 13. Again, the page header 402, the first page title 404, the content portion 406, the page footer portion 408 are used from the pre-formatted report structure 400 to generate the stylized report 446. Therefore, the report 446 provides an easy to use report of the physiological information from display portion 356 of FIG. 12. In the illustrated embodiment, only page one of three pages of the stylized report 446 is shown in FIG. 13.

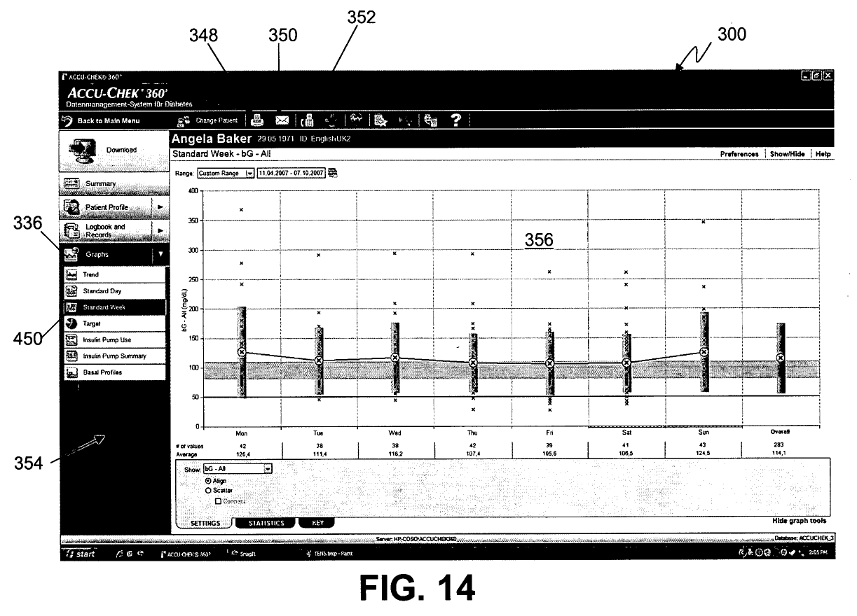

FIG. 14 illustrates the user interface 300 when the user selects the “Graphs” icon 336 on left hand menu 354. Various types of graphs or other physiological information may be selected including Trend, Standard Day, Standard Week, Target, Insulin, Pump Use, Insulin Pump Summary, and Basal Profiles. It is understood that additional physiological information may also be provided in other embodiments related to other physiological information measured by portable devices or otherwise.

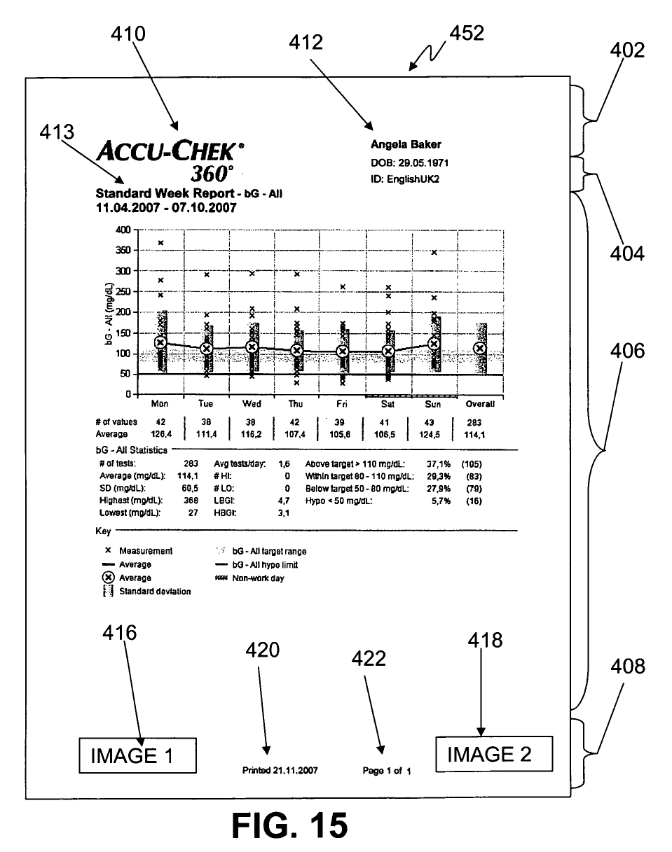

In the illustrated example of FIG. 14, the user has selected to display a standard week graph by selecting icon 450 from menu portion 354. Therefore, the standard week graph is displayed in display portion 356 of user interface 300. As discussed above, when a user desires to send the physiological information such as the standard week graph to an output device 112, the user illustratively selects the print icon 348, the e-mail icon 350 or the fax icon 352 from top menu 342 of user interface 300. The healthcare management system software 106 then uses the stylized, pre-formatted report structure 400 shown in FIG. 8 to generate the stylized report 452 shown in FIG. 15. Once again, the stylized report 452 includes the page header 402, the first page title 404, the content portion 406, and the page footer portion 408 from the stylized, pre-formatted report structure 400 shown in FIG. 8. Certain prior art systems print multiple blood glucose graphs (such as trend graphs, standard day, standard week and distribution) in a report format. However, the present invention uses a standardized report structure applied to multiple display screens of the user interface related to multiple features and functions as shown in FIGS. 5-15 for printing the displayed information within the healthcare management system and is not limited to blood glucose graphing information.

As discussed above, it is understood that other stylized pre-formatted reports may be used in accordance with the present invention to provide comprehensive, easy to understand output for physiological information displayed in display portion 356 of user interface 300. Therefore, the user can access the physiological and non-physiological information on the user interface 300 by selecting various items from menu 354. Once desired information is displayed on the display portion 356 of user interface 300, the user can send the information to an output 112 in a standard and stylized, pre-formatted report structure which is consistent regardless of the menu item selected. The stylized, pre-formatted report structure is always used when information displayed on the user interface is sent to the output device 112 (printer, e-mail, fax, or file) regardless of what the information looks like on the display of the user interface. Therefore, the present invention facilitates healthcare office work flow and communication between patients, healthcare professionals, managed care providers, healthcare maintenance organizations, and payors such as insurance companies.

Concepts described below may be further explained in one of more of the co-filed patent applications entitled HELP UTILITY FUNCTIONALITY AND ARCHITECTURE (Atty Docket: ROCHE-P0033), METHOD AND SYSTEM FOR GRAPHICALLY INDICATING MULTIPLE DATA VALUES (Atty Docket: ROCHE-P0039), SYSTEM AND METHOD FOR DATABASE INTEGRITY CHECKING (Atty Docket: ROCHE-P0056), METHOD AND SYSTEM FOR DATA SOURCE AND MODIFICATION TRACKING (Atty Docket: ROCHE-P0037), PATIENT-CENTRIC HEALTHCARE INFORMATION MAINTENANCE (Atty Docket: ROCHE-P0043), EXPORT FILE FORMAT WITH MANIFEST FOR ENHANCED DATA TRANSFER (Atty Docket: ROCHE-P0044), GRAPHIC ZOOM FUNCTIONALITY FOR A CUSTOM REPORT (Atty Docket: ROCHE-P0048), METHOD AND SYSTEM FOR SELECTIVE MERGING OF PATIENT DATA (Atty Docket: ROCHE-P0065), METHOD AND SYSTEM FOR PERSONAL MEDICAL DATA DATABASE MERGING (Atty Docket: ROCHE-P0066), METHOD AND SYSTEM FOR WIRELESS DEVICE COMMUNICATION (Atty Docket: ROCHE-P0034), METHOD AND SYSTEM FOR SETTING TIME BLOCKS (Atty Docket: ROCHE-P0054), METHOD AND SYSTEM FOR ENHANCED DATA TRANSFER (Atty Docket: ROCHE-P0042), COMMON EXTENSIBLE DATA EXCHANGE FORMAT (Atty Docket: ROCHE-P0036), METHOD OF CLONING SERVER INSTALLATION TO A NETWORK CLIENT (Atty Docket: ROCHE-P0035), METHOD AND SYSTEM FOR QUERYING A DATABASE (Atty Docket: ROCHE-P0049), METHOD AND SYSTEM FOR EVENT BASED DATA COMPARISON (Atty Docket: ROCHE-P0050), DYNAMIC COMMUNICATION STACK (Atty Docket: ROCHE-P0051), SYSTEM AND METHOD FOR REPORTING MEDICAL INFORMATION (Atty Docket: ROCHE-P0045), METHOD AND SYSTEM FOR MERGING EXTENSIBLE DATA INTO A DATABASE USING GLOBALLY UNIQUE IDENTIFIERS (Atty Docket: ROCHE-P0052), METHOD AND SYSTEM FOR ACTIVATING FEATURES AND FUNCTIONS OF A CONSOLIDATED SOFTWARE APPLICATION (Atty Docket: ROCHE-P0057), METHOD AND SYSTEM FOR CONFIGURING A CONSOLIDATED SOFTWARE APPLICATION (Atty Docket: ROCHE-P0058), METHOD AND SYSTEM FOR DATA SELECTION AND DISPLAY (Atty Docket: ROCHE-P0011), METHOD AND SYSTEM FOR ASSOCIATING DATABASE CONTENT FOR SECURITY ENHANCEMENT (Atty Docket: ROCHE-P0041), METHOD AND SYSTEM FOR CREATING REPORTS (Atty Docket: ROCHE-P0046), METHOD AND SYSTEM FOR CREATING USER-DEFINED OUTPUTS (Atty Docket: ROCHE-P0047), DATA DRIVEN COMMUNICATION PROTOCOL GRAMMAR (Atty Docket: ROCHE-P0055), and METHOD AND SYSTEM FOR MULTI-DEVICE COMMUNICATION (Atty Docket: ROCHE-P0064), the entire disclosures of which are hereby expressly incorporated herein by reference.

It should be understood that the concepts described below may relate to diabetes management software systems for tracking and analyzing health data, such as, for example, the ACCU-CHEK® 360° product provided by Roche Diagnostics. However, the concepts described herein may also have applicability to apparatuses, methods, systems, and software in fields that are unrelated to healthcare. Furthermore, it should be understood that references in this patent application to devices, meters, monitors, pumps, or related terms are intended to encompass any currently existing or later developed apparatus that includes some or all of the features attributed to the referred to apparatus, including but not limited to the ACCU-CHEK® Active, ACCU-CHEK® Aviva, ACCU-CHEK° Compact, ACCU-CHEK® Compact Plus, ACCU-CHEK® Integra, ACCU-CHEK® Go, ACCU-CHEK® Performa, ACCU-CHEK® Spirit, ACCU-CHEK® D-Tron Plus, and ACCU-CHEK® Voicemate Plus, all provided by Roche Diagnostics or divisions thereof.

Although the invention has been described in detail with reference to certain preferred embodiments, variations and modifications exist within the spirit and scope of the invention as described and defined in the following claims.

1. A healthcare management system configured to receive and process physiological information data related to at least one patient, the healthcare management system comprising:
a computing device configured to access and download physiological information data;
a memory accessible by the computing device to store the downloaded physiological information data;
a user interface having a display which receives display information from computing device;
software configured to operate on the computing device and implement a plurality of features and functions to manage the physiological information data, the software including instructions to display a plurality of user inputs on a menu portion of the display of the user interface to permit selections from the plurality of features and functions, the software also including instructions to display physiological information on a display portion of the display of the user interface adjacent the menu portion, the physiological information being displayed on the display portion of a plurality of different display screens based on the user input selections from the menu portion; and
means for generating a stylized report of the physiological information from the display portion of any of the plurality of different display screens, the generating means using a pre-formatted report structure for each of the plurality of different display screens.

2. The system of claim 1, wherein the pre-formatted report structure includes a header portion including identification information related to the at least one patient.

3. The system of claim 2, wherein the identification information includes a patient's name, a date of birth, and a patient identification number.

4. The system of claim 2, wherein the header includes a header image stored in the memory.

5. The system of claim 1, wherein the report structure includes a footer portion.

6. The system of claim 5, wherein the footer portion includes a page number.

7. The system of claim 5, wherein the footer portion includes a date of the report.

8. The system of claim 1, wherein the report structure includes at least one image stored in the memory which is combined with the physiological information from the display portion in the stylized report, the at least one image being at least one of a trademark, a coupon, an advertisement, and a reminder.

9. The system of claim 1, wherein the report structure includes a first page title portion.

10. The system of claim 1, wherein the report structure includes a content portion including the physiological information from the display portion of the display of the user interface.

11. The system of claim 1, further comprising means for sending the stylized report to an output device.

12. The system of claim 11, wherein the output device is one of a fax machine, an e-mail device, and a printer.

13. The system of claim 1, wherein the plurality of display screens includes a summary screen, a patient profile screen, a logbook and records screen, and a graphs screen, the same pre-formatted report structure being used to generate the stylized report from the display information in the display portion on each of the plurality of display screens.

14. The system of claim 1, wherein the displayed physiological information comprises reports and graphs related to the physiological information data.

15. The system of claim 1, wherein the displayed physiological information comprises at least one of diaries of blood glucose values; reports showing a plurality of blood glucose values and times to which the blood glucose values correspond; standard day reports wherein the blood glucose values are grouped according to the time of day taken; standard week reports wherein the blood glucose values are grouped according to the day of the week taken; and trend graphs to illustrate temporal trends in blood glucose values.

16. The system of claim 1, wherein the physiological information data is received from a portable device.

17. The system of claim 1, wherein the portable device is one of a meter, a pump and a PDA-type device.

18. A method for providing a stylized report of the physiological information from a healthcare management system configured to receive and process physiological information data related to at least one patient, the healthcare management system comprising a computing device configured to access and download physiological information data, a memory accessible by the computing device to store the downloaded physiological information data, and a user interface having a display which receives display information from the computing device; the method comprising:
providing a plurality of different features and functions to manage the physiological information data;
displaying a plurality of user inputs on a menu portion of the display of the user interface;
receiving a first user input selection from the user interface to select one of the plurality of different features and functions;
displaying physiological information on a display portion of the display of the user interface adjacent the menu portion, the physiological information being displayed on the display portion of a plurality of different display screens depending on the first user input received during the receiving step;
receiving a second user input to send physiological information being displayed on the display portion of the user interface to an output device;
generating a stylized report of the physiological information from the display portion of the user interface using a pre-formatted report structure for each of the plurality of different display screens; and
sending the stylized report to the output device.

19. The method of claim 18, wherein the output device is one of a fax machine, an e-mail device, and a printer.

20. A computer-readable medium having computer executable instructions for performing the method of claim 18.
